(19) United States
(12) Patent Application Publication
(10) Pub. No.: US 2023/0038164 A1
(43) Pub. Date: Feb. 9, 2023

(54) MONITORING AND ALERTING SYSTEM BACKED BY A MACHINE LEARNING ENGINE

(71) Applicant: Ava Naeini, Los Angeles, CA (US)

(72) Inventor: Ava Naeini, Los Angeles, CA (US)

(21) Appl. No.: 17/937,947

(22) Filed: Oct. 4, 2022

Related U.S. Application Data
(60) Provisional application No. 63/203,901, filed on Aug. 4, 2021.

(51) Int. Cl. G06F 11/36; G06N 5/02

(52) U.S. Cl. CPC G06F 11/3612; G06N 5/022

(57) ABSTRACT

A monitoring and alerting system backed by a machine learning engine for anomaly detection and prediction of time series data indicative of health of an application, a system, an environment, or a person. Using any data of interest that is modeled into a time series known as times and values; comparing input data against learned previous patterns; predicting data; identifying anomalies; generating notifications or an alert identifying the deviation, and communicating the alert to users, applications, or devices, applying the action or health functions logic using the significance of the issue to modify/start/stop components of the system or application. The data is received via a metrics server and is cleaned into a unified format and passed through via streaming or push/pull mechanisms. Planned deviations are configured to prevent false positives. A variety of machine learning methods is used and the system has dual function components and disaster recovery.

### CROSS-REFERENCE TO RELATED APPLICATION

This application claims the benefit of priority of U.S. provisional application No. 63/203,901, filed Aug. 4, 2021, the contents of which are herein incorporated by reference.

### BACKGROUND OF THE INVENTION

The present invention relates to information technology system monitoring and, more particularly, to a pattern recognition system monitoring tool.

We live in the era of data. Automation of processes run by an administrator or operator can save significant time and money. This domain is changing quickly, and it is very important to be able to detect patterns of change in the data and perform enhanced data analysis to automatically manage change at the time of rise.

It is very hard for system administrators to monitor a system when there are too many decisions to make to be able to configure the system. Existing tools do not have an automatic alerting mechanism in place and are not easy to use. They do not provide enough value or usability and thus are often not adopted.

Health of most systems and infrastructures in today's world is measured by varying degrees of change in metrics including throughput changes, latency changes, central processing unit (CPU) usage, memory consumption, garbage collection (GC) load, and more granular metrics that are application dependent, such as lag and queue size. These few metrics have been industry standard for decades for performance, resiliency, and scalability of systems under load for both distributed and non-distributed systems. These tools typically generate a lot of metrics, but only some are more relevant. They are business critical metrics that help an operator to understand the system's health. Corrective actions may include modifying the application code to bypass some of the “noise”. However, most of the time when a persistent pattern is detected, it is an excellent indicator that the client needs to scale up the hardware or infrastructure software.

A change in data patterns may signal an issue with the health of the system being monitored. Early detection of an anomaly can be important if not critical.

As can be seen, there is a need for a pattern recognition engine that is easy to use and provides an automatic alerting mechanism for detection of anomalies.

### SUMMARY OF THE INVENTION

In one illustrative embodiment of the present invention, an anomaly detection and prediction method comprises providing a monitoring mechanism having a stand-alone statistical and machine learning time series anomaly detection model comprising pattern recognition tools including: an anomaly detection unit; a prediction unit; a memory unit; a feature engineering unit; an aggregation unit; a control unit; a notification unit; an alerting unit; a system manager; a health check unit; and a user interface; monitoring and parsing metrics data indicative of health status of an application, a system, an environment, or a person into a unified shape and format for a fixed size of data and passed through from a metrics server per interval of time; comparing the metrics data against a learned pattern of time series data using the machine-learning time series anomaly detection model; identifying any deviation in the metrics data from the learned pattern; generating notifications or an alert identifying the deviation, wherein the alert is an alarm if the deviation is deemed to be a large, unexpected deviation or drastic signal shape; the alert is an incident report if the deviation is a single occurrence of change deemed critical; and the alert is a warning if the deviation is a trend showing a continuous increase while the application, system, environment, or person remains stable; identifying planned deviations to prevent a false positive alert; and communicating the alert to a user, a system operator, an internal component, and/or an external component.

In another illustrative embodiment of the present invention, a pattern recognition tool comprises a computer system operative to detect anomalies and to predict anomalies, having at least one processor; and at least one storage device coupled to the at least one processor, having instructions stored thereon which, when executed by the at least one processor, cause the at least one processor to be specifically configured to implement the method.

In another illustrative embodiment of the present invention, a non-transitory computer readable medium containing instructions for detecting and predicting anomalies, execution of which in a computer system causes the computer system to be specifically configured to implement a hybrid machine learning anomaly detector comprises the monitoring mechanism.

The inventive monitoring and alerting system backed by a machine learning engine provides accurate anomaly detection and prediction using any sort of metrics data of interest that can be modeled into a time series known as times and values to improve the performance and resiliency of data processing systems. The engine is a plug and play tool that may be attached to and monitor data streams and signals metrics. The software generates alerts identifying or predicting anomalies and delivers the alerts via a predetermined means, e.g., email, person, devices, etc. Using the alerts and significance, the system may re-start, start, and/or stop components of the system or application.

It has applications in a wide variety of fields, including but not limited to nature, biology and environmental use cases, human evolution, history studies, and climate change algorithms, and may be extended to use with two-dimensional (2D) images and movies, for example. For example, environmental signals may be monitored with respect to climate, temperature, population changes, and crisis management, providing probabilities in forecasting and reporting or alerting predictive weather changes, thereby enabling better crisis management by having responsive, manageable systems. The system may be used in animal studies to analyze harmless lab-related procedures. The invention may improve environmental awareness by advancing overall understanding of changes in natural patterns over time and compressing them for evolution studies. The inventive engine may be used in healthcare, for example as a blood diagnosis tool, in glucose monitoring, in DNA analysis, and in heartrate monitoring, i.e., it may be used as a pattern recognition tool for changes in a heartbeat.

These and other features, aspects and advantages of the present invention will become better understood with reference to the following drawings, description, and claims.

### BRIEF DESCRIPTION OF THE DRAWINGS

FIG. 1 is a flowchart of an anomaly detection and prediction method according to an embodiment of the present invention;

FIG. 2 is a schematic flow diagram of an anomaly detection and prediction system according to an embodiment of the present invention;

FIG. 3 is a schematic illustrating various use cases for the method of FIG. 1 and the system of FIG. 2;

FIG. 4 is a schematic diagram of all system components according to an embodiment of the present invention; and

FIG. 5 is a schematic view of a disaster recovery system according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a monitoring mechanism backed by a stand-alone statistical and machine learning modeling engine that detects anomalies and abnormal behavior in important system metrics and generates alerts. This engine may be applied to metrics regarding distributed systems such as Kafka® clusters, managed by Confluent® software where Java Management Extensions (JMX®) and other metrics are produced by the system. Metrics are performance measures that are time series, such as CPU, memory usage, available disk space, and Java Management Extensions (JMX®) values that are internal metrics of Confluent® software. The engine has the ability to monitor itself and the system it operates on for fault tolerance and resiliency. There is a configurable shadow instance that acts as a passive instance in case of fail overs which allows for reliability of monitoring critical use cases like crisis management, finance, and movement use cases where it is important to have 0 downtime and no service interruption.

The inventive tool is a health engine that is sometimes referred to herein as “Pulse”. Pulse is a machinery model of human intelligence that follows human cognitive approaches in analytical processing of signals & systems studies. Pulse learns patterns and detects abnormal behaviors using a hybrid approach of various highly accurate machine learning methods paired with enriched feature extraction and a correlation matrix that supports input that may or may not be used throughout the process based on how the system is configured. The engine does not require a massive historical database. Rather, it may be operated with about a week of metrics information that may be continuously refreshed. Further, the engine analyzes a predetermined number of metrics to identify patterns without producing excess information.

Pulse is a proactive “health engine” with a set of supported pattern recognition tools to detect anomalies and drastic changes in system health metrics. It may provide the status of a system. It allows users to associate a model with their metrics and monitor the system. Pulse enables DevOps teams to enable anomaly detection on their data of interest and be aware of change. It detects anomalies by comparing the expected patterns with observed patterns. In this context, an anomaly is an unexpected variation in a system's behavior. The tool detects anomalies by recognizing certain patterns of specific variables that define normal behavior. Variables in this context are system and application metrics. By identifying any change in pattern, the tool detects when a system is deviating from its normal state.

The anomaly detection method utilizes an approach based on convolutional neural networks known as DeepAnT. See Munir, M., Siddiqui, S. A., Dengel, A., & Ahmed, S. (2018). DeepAnT: A deep learning approach for unsupervised anomaly detection in time series. IEEE Access, 7, 1991-2005. The disclosure of Munir et al. is incorporated by reference herein in its entirety. The method is highly parameterized due to the nature of machine learning as well as data domain dependency of algorithms and hence it needs to be trained for each new data domain in most cases. For example, the method may utilize hidden layers, edge detection filters, Fourier Transform filters, window size, and maximum pooling. Hence, the idea can only be developed and generalized to a degree that is measurable to prove the solidity of the invention. As the method is unsupervised, the data sets do not need to be labelled.

References discussed herein have been selected by the Applicant as the most recent and highly accurate of a large pool of prior art in the area of machine learning and are not intended to be limiting.

Custom-made internal processes and methods may vary. Some may be equipped with rule engines, some may use learning models, and some may be paired with feedback loops. The flow and relationship between components are consistent but the logic of each component behaves independently in cases without external inputs.

The system described herein may be produced using a combination of languages like Java®, C/C++, and Python®.

The present invention provides a pattern recognition tool that detects, recognizes, and understands patterns of time series and performs predictive analysis and anomaly detection. This tool has a wide range of applications including building monitoring and observability tools for distributed systems, life sciences and genetics (e.g., DNA sequencing), image processing, advanced sciences and math, electrocardiogram (EKG) monitoring, stock prediction, forecasting, climate change, and filtering.

Pulse uses domain knowledge along with models developed to optimize detection accuracy of predictive changes in time to monitor a system with minimal effort. Neural network and gradient methods may be leveraged against massive amounts of data to solve optimization problems at low-cost in managing distributed systems. The tool may use neural networks to identify a pattern from data and to identify when the data deviates from the learned pattern. Planned variations may be identified so that the tool does not issue a false positive alert.

Models are trained tools that are classified in groups based on their functionality to detect anomalies or patterns of change within a certain window of time. The engine may be applied to any time series or any shape or form of data and may have feature detection mechanisms and anomaly detection and prediction units as well as configurable thresholds to train models against different values and apply simple heuristics.

A Markov chain memory model may be used as a prediction unit to support trends analysis and use of feedback loops to the system for enhanced learning. See, for example, Wilinski, A. (2019). Time series modeling and forecasting based on a Markov chain with changing transition matrices. Expert Systems with Applications, 133, 163-172. The Wilinski disclosure is incorporated herein in its entirety by reference.

A gradient model measures the degree of change over time and may be suitable when metrics values are generally steady or have continuous or sudden increase, such as for CPU, memory, latency, and disk usage. The gradient model generally evaluates the maximum, minimum, and median values of a metric rather than the signal shape, ensuring that the utilization of a physical limit is always below its acceptable maximum and the degree of change is manageable.

The system may also be trained for pattern matching. Observed behavior may be matched to a representative pattern and used to determine when changes are expected within certain time windows (W). Usually, when systems utilize batch jobs to offload data, it occurs within certain time periods during which spikes of load may be considered normal. Data migration in extract, transform and load (ETL) systems and integration systems are common examples of such patterns. Thus, the system may focus on anomalies that represent unexpected large deviations and/or drastic signal shape changes

These anomalies trigger alarms to notify the system operators with suggested actions that may be taken to fix the issue on the fly or to prevent future down times, depending on the levels of severity, while causing minimal discomfort to the staff. The alarms may notify internal and external components if health of a component is at risk. A correlation matrix may be used as an input to relate changes, making them easier for the user to analyze and debug. A user may manually specify a correlation between metrics of interest. The correlation matrix of metrics may be used to make suggestions of metrics an operator may investigate to determine the cause of an anomaly or to take actions to correct the anomaly. This may be called a suggestion log. The user may optionally set a priority.

A single occurrence of a change deemed critical may trigger an incident report. For example, a 50% increase in throughput, latency, CPU, memory, or disk may trigger an incident report.

If a trend showing a continuous increase is identified while the system remains stable, a warning may be issued. The trend may not necessarily be critical. For example, a 10-15% change every 5 minutes while the system is not under maintenance, its initial load period, or data migration may trigger a warning. The system may have a “snooze” feature that temporarily deactivates a warning for a planned resource use increase, an expected bulk load, or a test.

The inventive tool may generate a report including a health score indicating, for example, that “config a,b,c” needs attention.

Pulse may be equipped with a recommendation engine. This tool works based on a user-defined correlation matrix (a manual recommendation engine that specifies correlations between monitored metrics) and may make suggestions about observed changes that help determine what cause or causes contributed to the anomaly or if multiple causes are rippling across various parts of the system. This recommendation tool makes troubleshooting much easier, faster, and less stressful and saves users time and money on ongoing maintenance of enterprise scale systems. Moreover, it not only applies to in-house applications hosted within proprietary hardware but works brilliantly on cloud applications since the engine operates based on what a system is producing, regardless of where it is hosted.

A custom user interface (UI) may be implemented against the engine and plugged to the user's systems or the full end to end application may be used for a Kafka® (computer software/platforms for collecting, processing, storing, securing, and delivery of large amounts of data simultaneously in real time) use case. The UI may exhibit Kafka®-specific metrics, such as consumer lag alerts; queue size; under-replicated partitions; leader election rates; offline topic partitions; consumption throughput anomalies; production throughput anomalies; latency anomalies; and CPU/memory and Java virtual machine (JVM) utilization limits.

A method of using the pattern anomaly detection tool may include the following. First the user may parse the metrics into a unified shape and format for a fixed size of data in every interval of time. Descriptors and signal indicators that differentiate between two signals may include, but are not limited to amplitude, frequencies, gradient patterns, and edges. The user may extract feature vectors that represent a signal such as min, max, average, median, and/or standard deviation. Features are key attributes that represent a signal, e.g., minimum, maximum, median, mean, and/or standard deviation. The engine uses a combination of features, as they have different benefits and an aggregate component aggregates the probability score of each component output. A distance metric may analyze the sum of variations between the feature vectors maximum, mean, and standard deviation. Their distribution helps recognize categories or classes. Edge detection filters may capture how the signal changes by sampling data and calculating edges. Edges display direction and angle of change of a data set. The number of edges extracted over a period of time may be configured. For example, a value of about 10 to about 100 may avoid overfitting classifying methods. A gradient may be calculated for certain metrics that are steadier and a neural network may be trained with multiple hidden layers, e.g., about two internal layers, against various dimensions of attribute and learn different patterns. For example, a Feature Detection Layer may include edge detection set features; slope; change degree based on a threshold; and raw values. A Convolution Layer may measure convergence. The model may then be turned on to start determining if a pattern belongs to the system's normal behavior or is a change. The user may be notified when change occurs determined by the model or based on a threshold. Apply measures against results produced by a model.

Disaster recovery (DR) mode is a mechanism that makes the system fault tolerant, and continues monitoring during, for example, instance failures or disasters such as a fire. The inventive disaster recovery mode is a second layer on top of the distributed system with a switch server. The system copies and backs up models, configs and switches over using the switch server. The switch server is hosted somewhere other than a server where the primary instance is hosted, and it switches detects the livelihood of the control unit by a ping request if it receives from it. The control unit may pause and restart processes automatically.

Embodiments of the present invention accomplish one or more of the following advantages:
1. An enhanced monitoring tool that has dual functionality and monitors itself and the application it sits on.
2. A hybrid approach of proven highly accurate machine learning methods that uses an aggregate of Neural Network, Markov Chain and threshold functions to determine if a signal is normal or abnormal.
3. Using Markov memory model to support the trends and provide that back to the system using feedback loops for enhanced learning and using a memory feature in time series.
4. Providing fault tolerance by building disaster recovery mechanisms and a copy/fallback instance as part of the system design and development to make sure sanity of the overall system is being backed up at the core to be able to restore and support the applications that are being monitored continuously in case of incidents or natural disasters in the servers that primary is hosted.
5. Design of a control unit that has action functions related to the system components that's able to notify, alert and send action signals to the system manager for restart of the components.
6. Design of various components that have dual function of handling application as well as system tasks in a seamless manner.
7. Incorporation of analytical methods within the healthcheck and dynamic visualization of metrics for the enhancement of UI/user experience (UX) when it comes to visualization of a large number of data points.
8. Using a variety of feature extraction methods and performing optimization during learning to pick the top performers as learning converge.
9. Design of a system manager that solely performs operational tasks for application and system for restart/stop/start of application and system components.
10. Having the ability to restart the back-up system using switch server.
11. Using correlation matrix as a learned feature or support input to bring the relationship between changes to the forefront of the user experience for dynamic views and faster debugging.
12. Incorporation of a metrics server for uniformly cleaning, filtering, and processing data that needs to be ported to the system.
13. Provide a tiered approach in system status monitoring that allows for better visualization of change.
14. Automation of operational and system changes via control unit and system manager in a seamless manner to support a lot of processes that are time consuming and burdening engineering in an intelligent workflow.
15. Predicting signal values using trend over time windows.

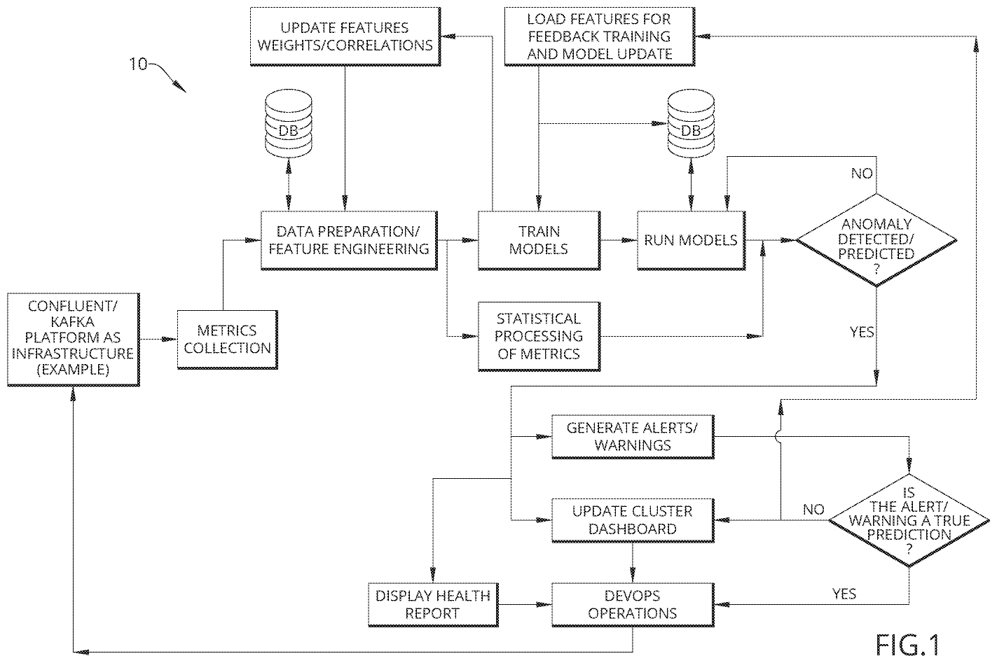

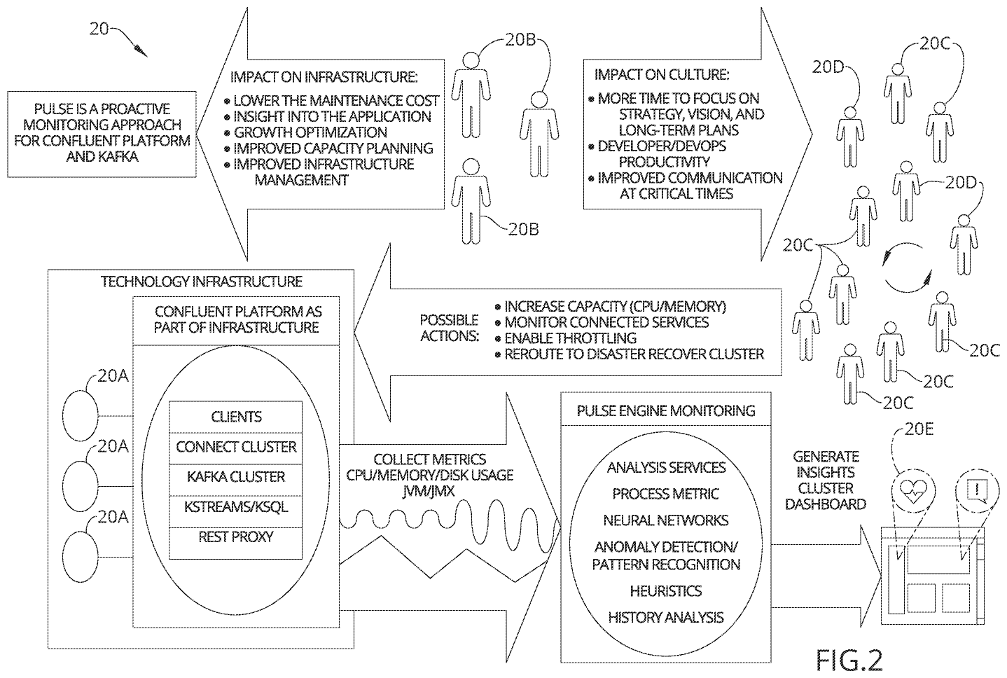

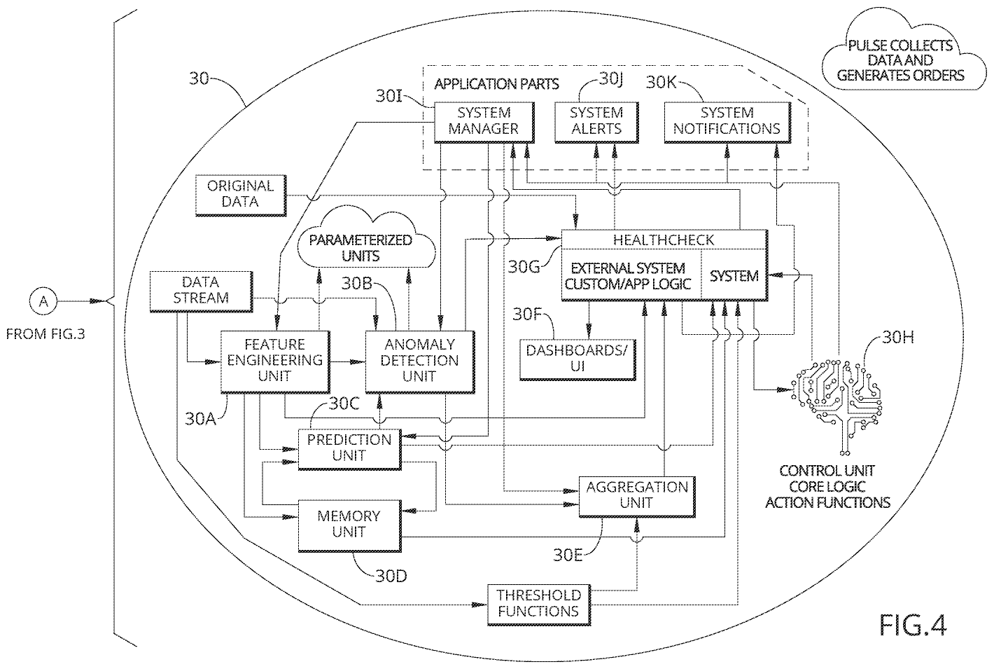

Referring to FIGS. 1 through 5, FIG. 1 illustrates a method of operation of the inventive health engine 10 according to an embodiment of the present invention. In this example, the engine 10 is operated with a Confluent®/Kafka® platform as infrastructure. Metrics may be collected, stored, and used to train models. The features, weights, and correlations may be updated if appropriate. The models may be run and the results combined with statistical analysis of the metrics to determine if an anomaly has been detected or is predicted. If no anomaly has been identified, the models may be run again and the results may be stored. If an anomaly has been detected, an alert and/or warning 30J (see FIG. 4) may be generated and a cluster dashboard 30F (see FIG. 4) may be updated to display the results. The health engine 10 may also collect and check configuration information from the infrastructure platform and display a health report 20E (see FIG. 2) to the DevOps Operations team 20C (see FIG. 2). If the user determines that the alert or warning 30J was a true prediction, the DevOps Operations team 20C may make appropriate changes to the system. If the user determines that the alert or warning 30J was not a true prediction, feedback is collected to train and update the model.

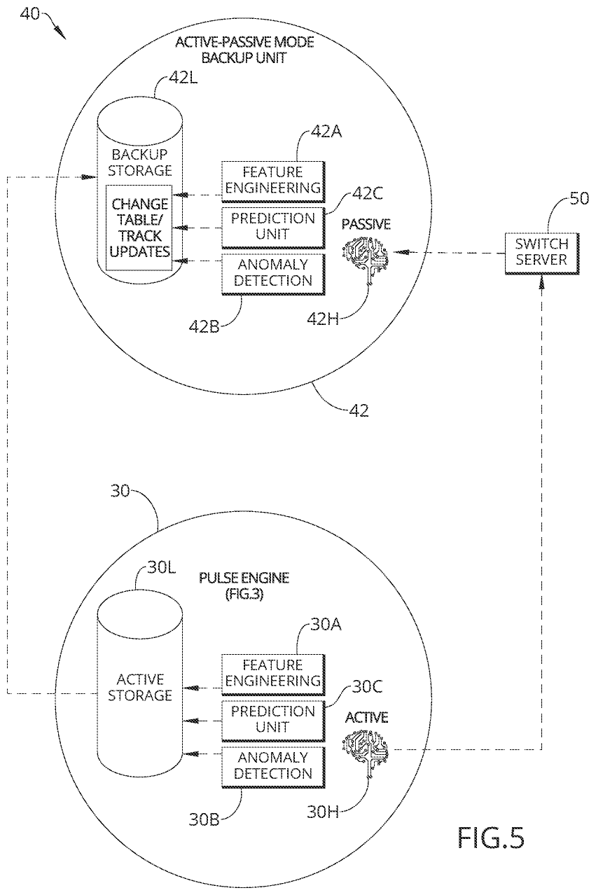

The schematic 20 of FIG. 2 illustrates impacts of the system and interactions with technology leaders 20B, DevOps or DevOpps 20C, and developers 20D. Potential downstream (connected) services that talk to part of the infrastructure that has the Confluent® platform are shown. The box at the bottom left provides a simplified model of technology infrastructure comprising a Confluent® platform with clients, stream processing applications like Kafka®, and connected or neighboring microservices 20A, with data flow in both directions. Time series metrics, including CPU, memory usage, disk usage, JVM/JMX values, and configuration files are ported to the monitoring engine 10 (see FIG. 1) from the platform for further processing and anomaly detection or prediction assessments. The monitoring engine 10 generates reports of insights and configuration data and displays the reports with any configuration values that can create vulnerability as well as notifications 30K (see FIG. 4) for anomalies on an insights cluster dashboard 30F (see FIG. 4), together with a health indicator 20E and a score. Based on the insights and alerts produced by the inventive tool, the DevOps 20C developers 20D may increase capacity (whether CPU or memory), monitor connected services, enable throttling, and/or reroute operations to a disaster recovery cluster 40 (see FIG. 5).

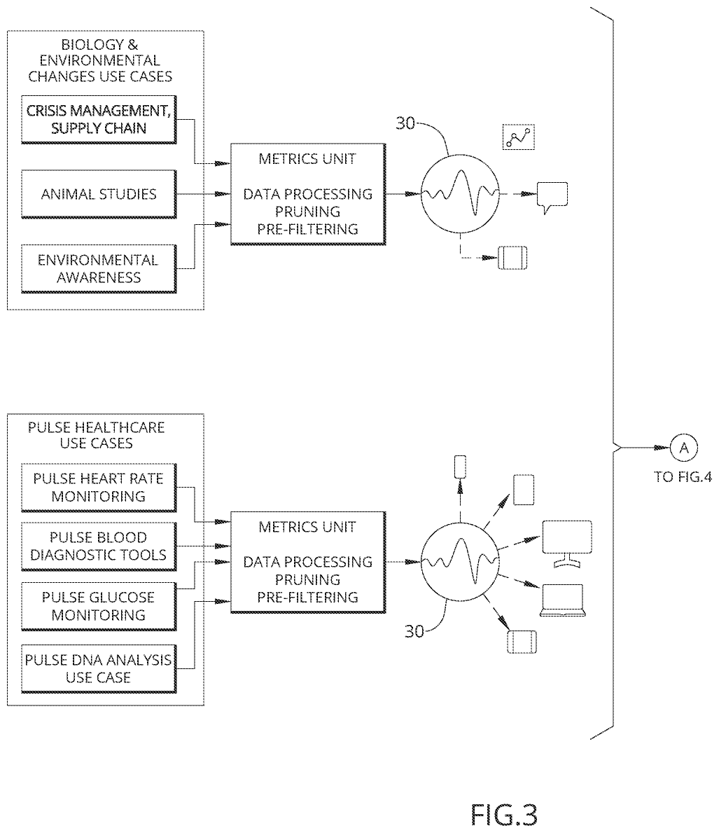

As shown in FIG. 3, the ML engine 30 may be used in a variety of use cases, such as biology and environmental change and healthcare.

The ML engine 30 may have several components, as illustrated in FIG. 4, including a Feature Engineering Unit 30A; an Anomaly Detection Unit 30B; a Learning Processes or Prediction unit 30C; a Memory Unit 30D; an Aggregation Unit 30E; Dashboards/UI 30F; a Healthcheck unit 30G; a Control Unit 30H; and a System Manager 301. The Control Unit 30H issues System Alerts via an alerting unit 30J and System Notifications via a notification unit 30K based on the Healthcheck unit 30G analysis.

The engine 30 may include a disaster recovery system 40, as shown in FIG. 5, including a backup unit 42, comprising a feature engineering unit 42A, an anomaly detection unit 42B, and a prediction unit 42C functioning in conjunction with a passive control unit 42H. The models are saved to a backup storage device 42L which tracks updates to the models in a change table. The disaster recovery system 40 switches operation from a primary host server 30 to a secondary host server 42 by way of a switch server 50.

Control and Action Components have two sections. Each section is dedicated to either the App/Use Case logic or the System (engine internal) flows. System Flow always takes priority over the flows that are related to the application logic. A control unit 30H handles action functions that are related to restarting the system components, alerting, or notifications for the system. All the signals related to the system are managed by the control unit 30H that knows the underlying importance of each component in case one fails. The healthcheck unit 30G has health functions. The logic of health lives there for both use case and system. Containerization such as use of Kubernetes® (K8) or Docker® may be used to manage resources for system components, making sure consumption is managed separately, to de-risk the application and make the maintenance and monitoring risk averse. Procedures that run within Pulse are application agnostic and are data centric.

It should be understood, of course, that the foregoing relates to exemplary embodiments of the invention and that modifications may be made without departing from the spirit and scope of the invention as set forth in the following claims.

What is claimed is:

1. An anomaly detection and prediction method comprising:
providing a monitoring mechanism having a stand-alone statistical and machine learning time series anomaly detection model comprising pattern recognition tools including: an anomaly detection unit; a prediction unit; a memory unit; a feature engineering unit; an aggregation unit; a control unit; a notification unit; an alerting unit; a system manager; a health check unit; and a user interface;
monitoring and parsing metrics data indicative of health status of an application into a unified shape and format for passed through from a metrics server to processing units;
comparing the metrics data against a learned pattern of time series data using the stand-alone statistical and machine-learning time series anomaly detection model, prediction scores;
identifying any deviation in the metrics data from the learned pattern;
aggregating results;
generating an alert identifying the deviation, wherein the alert is an alarm if the deviation is deemed to be a large, unexpected deviation or drastic signal shape; the alert is an incident report if the deviation is a single occurrence of change deemed critical; and the alert is a warning if the deviation is a trend showing a continuous increase while the application remains stable;
identifying planned deviations to prevent a false positive alert; and
communicating the alert to a user, a system operator, an internal component, and/or an external component.

2. The anomaly detection and prediction method of claim 1, further comprising disaster recovery steps, including monitoring continuously; copying and backing up the stand-alone statistical and machine-learning time series anomaly detection model to a secondary server; switching to the secondary server; and recording changes in secondary change tables for faster future restore of an original instance.

3. The anomaly detection and prediction method of claim 1, wherein the metrics data includes amplitude, frequency, gradient pattern, and edges.

4. The anomaly detection and prediction method of claim 1, wherein the metrics data includes CPU usage, memory usage, latency, and available disk space.

5. The anomaly detection and prediction method of claim 1, wherein the stand-alone statistical and machine-learning time series anomaly detection model comprises a neural network, a Markov chain memory model, and threshold functions utilized in aggregate to determine if a signal is normal or abnormal.

6. The anomaly detection and prediction method of claim 5, wherein the Markov chain memory model utilizes feedback loops to support trends and provide a result back to the stand-alone statistical and machine-learning time series anomaly detection model to improve accuracy.

7. The anomaly detection and prediction method of claim 5, wherein the stand-alone statistical and machine-learning time series anomaly detection model further comprises reinforcement learning, convolutional neural network hidden layers, edge detection filters, Fourier Transform filters, window size, and maximum pooling.

8. A pattern recognition tool comprising a computer system operative to detect anomalies and to predict anomalies, having:
at least one processor; and
at least one storage device coupled to the at least one processor, having instructions stored thereon which, when executed by the at least one processor, cause the at least one processor to be specifically configured to implement a method of detecting the anomalies and predicting the anomalies comprising:
providing a monitoring mechanism having a stand-alone statistical and machine learning modeling comprising pattern recognition tools including: an anomaly detection unit; a prediction unit; a memory unit; a feature engineering unit; an aggregation unit; a control unit; a notification unit; an alerting unit; a system manager; a health check unit; and a user interface;
monitoring and parsing metrics data indicative of health status of an application into a unified shape and format for a fixed size of data and passed through from a metrics server per interval of time;
comparing the metrics data against a learned pattern of time series data using the stand-alone statistical and machine-learning time series anomaly detection model;
identifying any deviation in the metrics data from the learned pattern;
generating an alert identifying the deviation, wherein the alert is an alarm if the deviation is deemed to be a large, unexpected deviation or drastic signal shape; the alert is an incident report if the deviation is a single occurrence of change deemed critical; and the alert is a warning if the deviation is a trend showing a continuous increase while the application remains stable;
identifying planned deviations to prevent a false positive alert; and
communicating the alert to a user, a system operator, an internal component, and/or an external component.

9. The pattern recognition tool of claim 8, further comprising disaster recovery including a copy/fallback instance operative to restore the application in response to an incident.

10. The pattern recognition tool of claim 8, wherein the control unit is operative to notify, alert, and send action signals to the system manager for restart of components, to send alerts to system alerts, to send notifications to system notification, and to send pings to a switch server.

11. The pattern recognition tool of claim 8, wherein the user interface is operative to provide dynamic visualization of metrics.

12. The pattern recognition tool of claim 8, wherein the system manager is operative to restart, stop, or start the application and system components upon predetermined criteria.

13. The pattern recognition tool of claim 8, further comprising a switch server operative to switch processing to a passive instance and a backup mechanism to backup data.

14. The pattern recognition tool of claim 8, further comprising a recommendation engine having a correlation matrix operative to correlate changes between monitored metrics.

15. The pattern recognition tool of claim 8, further comprising a metrics server operative to uniformly store and process data.

16. The pattern recognition tool of claim 8, wherein the control unit and the system manager are operative to seamlessly automate operational and system changes.

17. The pattern recognition tool of claim 8, further comprising trend over time windows operative to predict signal values.

18. The pattern recognition tool of claim 8, wherein the pattern recognition tool monitors itself and the application using dual components and the control unit.

19. A non-transitory computer readable medium containing instructions for detecting and predicting anomalies, execution of which in a computer system causes the computer system to be specifically configured to implement a hybrid machine learning anomaly detector comprising:
a monitoring mechanism having a stand-alone statistical and machine learning time series anomaly detection model comprising pattern recognition tools including: an anomaly detection unit; a prediction unit; a memory unit; a feature engineering unit; an aggregation unit; a control unit; a notification unit; an alerting unit; a system manager; a health check unit; and a user interface; wherein the monitoring mechanism is operative to:
monitor and parse metrics data indicative of health status of an application into a unified shape and format for a fixed size of data and passed through from a metrics server per interval of time;
compare the metrics data against a learned pattern of time series data using the stand-alone statistical and machine-learning time series anomaly detection model;
identify any deviation in the metrics data from the learned pattern;
generate an alert identifying the deviation, wherein the alert is an alarm if the deviation is a large, unexpected deviation or drastic signal shape; the alert is an incident report if the deviation is a single occurrence of change deemed critical; and the alert is a warning if the deviation is a trend showing a continuous increase while the application remains stable;
identifying planned deviations to prevent a false positive alert; and
communicate the alert to a user, a system operator, an internal component, and/or an external component.

20. The non-transitory computer readable medium of claim 19, further comprising a disaster recovery module operative to continuously monitor during a disaster; copy and back up the stand-alone statistical and machine-learning time series anomaly detection model to a secondary server; track changes to the stand-alone statistical and machine-learning time series anomaly detection model for reversion and/or debugging; and switch to the secondary server.
